(19) United States
(12) Patent Application Publication
(10) Pub. No.: US 2005/0226464 A1
(43) Pub. Date: Oct. 13, 2005

(54) Camera control system to follow moving objects

(76) Inventors: Ying Sun, Wakefield, RI (US); Xu Han, Kingston, RI (US); Yu Guo, Kingston, RI (US)

Correspondence Address: Gauthier & Connors LLP;Suite 3300, 225 Franklin Street, Boston, MA, 02110, US

(21) Appl. No.: 10/985,179

(22) Filed: Nov. 10, 2004

Related U.S. Application Data
(63) Continuation of application No. PCT/US03/15380, filed on May 15, 2003.
(60) Provisional application No. 60/380,665, filed on May 15, 2002.

(51) Int. Cl. G06K 9/00

(52) U.S. Cl. 382/103

(57) ABSTRACT

The present invention is directed to an image tracking system that tracks the motion of an object. The image processing system tracks the motion of an object with an image recording device that records a first image of an object to be tracked and shortly thereafter records a second image of the object to be tracked. The system analyzes data from the first and the second images to provide a difference image of the object, defined by a bit map of pixels. The system processes the difference image to determine a threshold and calculates a centroid of the pixels in the difference image above the threshold. The system then determines the center of the difference image and determines a motion vector defined by the displacement from the center to the centroid and determines a pan tilt vector based on the motion vector and outputs the pan tilt vector to the image recording device to automatically track the object.

### PRIORITY DATA

This application claims the benefit of U.S. Provisional Application No. 60/380,665, filed May 15, 2002, and hereby incorporated by reference.

### BACKGROUND OF THE INVENTION

The invention relates to imaging systems for tracking the motion of an object, and in particular to imaging systems that track the real-time motion of an object.

Real-time imaging and motion tracking systems find application in fields such as surveillance, robotics, law enforcement, traffic monitoring, and defense. Several image-based motion tracking systems have been developed in the past. These systems include one from the AI lab of Massachusetts Institute of Technology (Stauffer et al., “Learning Patterns of Activity Using Real-Time Tracking”, IEEE Trans. PAMI, pp. 747-757, August 2000; Crimson et al., “Using Adaptive Tracking to Classify and Monitor Activities in a Site”, Computer Vision and Pattern Recognition, pp. 22-29, June 1998), the W⁴ System of University of Maryland (Haritaoglu et al., “W4. Real-Time Surveillance of People and Their Activities”, IEEE Trans. PAMI, pp. 809-830, August 2000), one from Carnegie Mellon University (Lipton et al., “Moving Target Detection and Classification from Real-Time Video”, Proc. IEEE Workshop Application of Computer Vision, 1998), a system based on edge detection of objects (Murray et al., “Motion Tracking with an Active Camera” IEEE Trans. on Pattern Analysis and Machine Intelligence, 16(5):449-459, May 1994), a system using optical flow (Daniilidis et al., “Real time tracking of moving objects with an active camera” J. of Real-time Inaging, 4(1):3-90, Feb. 1998), and a system using binocular vision (Coombs et al., “Real-time binocular smooth pursuit. Int. Journal of Computer Vision” 11(2):147-164, October 1993). However, these systems are computationally intensive and generally require very high performance computers to achieve real-time tracking. The tracking system of the AI lab used an SGI 02 workstation with a R10000 processor to process images of 160×120 pixels at a frame rate up to 13 frames per second. The other systems used multiple cameras, each covering a fixed field of view or adaptive and model-based algorithms that required extensive training for recognizing specific objects and/or scenes.

Therefore, there is a need for an imaging system that tracks the motion of an object that is more efficient, less computationally intensive and more effective than the aforementioned systems.

### SUMMARY OF THE INVENTION

The invention broadly comprises an image processing system and method for tracking the motion of an object.

The image processing system tracks the motion of an object with an image recording device that records a first image of an object to be tracked and shortly thereafter records a second image of the object to be tracked. The system analyzes data from the first and the second images to provide a difference image of the object, defined by a bit map of pixels. The system processes the difference image to determine a threshold and calculates a centroid of the pixels in the difference image above the threshold. The system then determines the center of the difference image and determines a motion vector defined by the displacement from the center to the centroid and determines a pan tilt vector based on the motion vector and outputs the pan tilt vector to the image recording device to automatically track the object.

The image recording device may be a digital video camera that includes a drive system to move the camera (e.g., a motor driven camera mount), a computing device (e.g., a PC) and a closed-loop tracking routine that is executed by the computing device. The system automatically tracks a moving object in real-time. The image recording device records images of the object to be tracked to provide an image sequence thereof. The system processes the image sequence to determine a motion vector. The motion vector is then used to determine how the pan and tilt of the image recording device must be adjusted to track the objects and maintains the moving object at the center of the view of the image recording device.

The image recording device may record images at a constant frame rate and feed them to the computing device. The computing device estimates the displacement vector of the moving object in the recorded sequence and based on the displacement vector controls no the movement (e.g., the pan and tilt) of the image recording device. The system uses the difference between two adjacent images of the image sequence to obtain a profile of the moving object, while removing the background or any stationary object recorded in the image sequence. From the difference image, the centroid of the moving object is determined by averaging the positions of object pixels.

These and other objects, features and advantages of the present invention will become more apparent in light of the following detailed description of the preferred embodiments thereof, as illustrated in the accompanying drawings.

### BRIEF DESCRIPTION OF THE DRAWINGS

FIG. 1 is a schematic diagram an imaging system for tracking the motion of an object;

FIG. 2 is a pictorial illustration of processing steps applied to images to track the motion of an object within the image;

FIG. 3 depicts a vertical projection of a pinhole model;

FIG. 4 depicts a horizontal projection of a pinhole model;

FIG. 5A depicts a recorded image of a white card having a black dot printed on the center of the card; and

FIG. 5B depicts a recorded image of the white card shown in FIG. 5A in a different location from that shown in FIG. 5A.

FIG. 6 is a graph showing the relations between displacement on the image plane and actual displacement for different object planes.

### DETAILED DESCRIPTION OF THE INVENTION

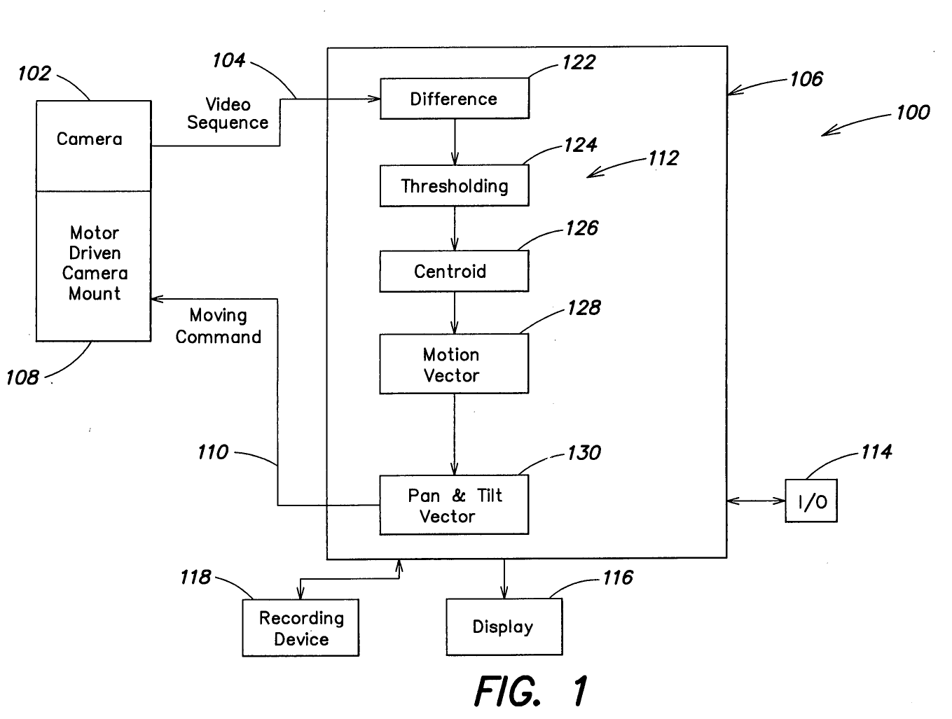

FIG. 1 is a block diagram illustration of an imaging system 100 for tracking the motion of an object within an imaged scene. The system 100 includes a camera 102 that images a scene and provides frames of image data on a line 104 to a processing device 106. The processing device 106 may include a general purpose computing device such as a personal computer (PC).

The camera may be a standard web camera that provides digital video images which have a resolution for example of 320×240 pixels and a frame rate for example of 25 frames per second. The web camera may be connected a computing device via a USB port. The camera 102 is mounted on a motor-driven camera mount 108 (Surveyor Corporation) that receives commands on a line 110 from the computing device PC via a RS232 serial port. The camera mount 108 can pan the camera 102 left and right by 180 degrees, and tilt the camera 102 up and down by 180 degrees. The imaging system 100 is capable of tracking moving objects such as a person walking in the room.

The computing device 106 includes a processor that executes an object tracking routine 112 which may be coded for example in C++. The computing device 106 communicates with various input/output (I/O) devices 114, a display 116 and a recording device 118.

The object tracking routine 112 preferably runs in real-time and is fast enough to automatically keep up with the moving objects. The object tracking routine 112 defines the object by its motions. That is, the routine 112 does not rely on an object model, thereby avoiding the computation-intensive tasks such as object model matching and pixel-based correlation. The system controls the camera mount 108 with information derived from the image recording device. The object to be tracked is identified from between two adjacent images as the object moves. Because only moving objects appear in a difference image, the routine 112 effectively suppresses the background and reduces the computational effort. With the use of a centroid from the difference image it is not necessary to know the precise shape of the object. All that is needed for controlling the camera 102 is the displacement of the centroid of the object from the center of the image.

A threshold is used to determine whether each pixel has changed enough to be included in the moving object. The computation for the centroid is simply the average of the x-y coordinates of the object pixels. The pan-tilt vector controls the aiming of the camera 108 so that the tracked object can be maintained in the center of the field of view of the camera 108.

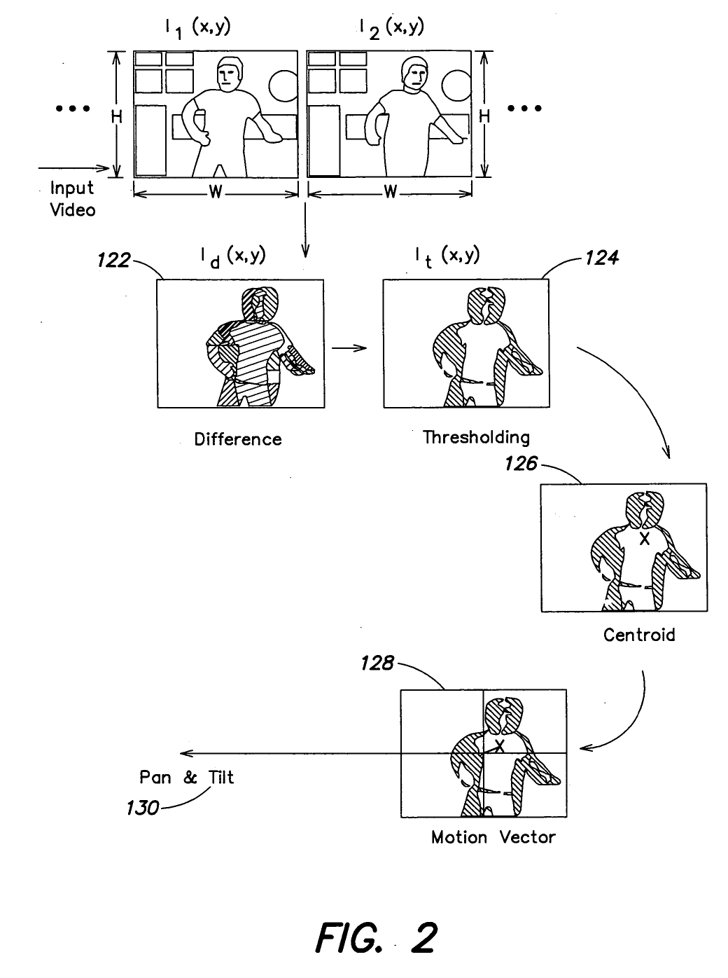

The object tracking routine 112 includes a plurality of processing steps that comprises: frame subtraction; thesholding; computing centroid; motion-vector extraction; and determining pan and tilt. The schematic shown in FIG. 2 illustrates how the object tracking routine 112 is accomplished. The object tracking routine shall now be discussed se processing steps are defined mathematically as follows.

The steps are completed in one program loop so that the throughput of the control path of the system 100 is high. The closed loop control of the system 100 provides real-time tracking of the moving object.

Referring to FIGS. 1 and 2, the two adjacent-image frames from the video sequence are denoted as I₁(x, y) and I₂(x, y). The width and height for each frame are W and H, respectively. Assume that the frame rate is sufficiently high with respect to the velocity of the movement, the difference between I₁(x, y) and I₂(x,y) should contain information about the location and incremental movements of the object. The difference image can be determined in step 122, and expressed as:
I_{d}(x, y)=|I₁(x, y)−I₂(x, y)| (1)

The frame subtraction reduces the background and any stationary objects. The difference image is thresholded in step 124 into a binary image according to the following relationship:

$${I}_{t} ( x , y ) = \{ \begin{matrix}1 & {I}_{d} ( x , y ) > α \\ 0 & {I}_{d} ( x , y ) \leq α\end{matrix} \qquad ( 2 )$$

where α is a threshold that determines the tradeoff between sensitivity and robustness of the tracking algorithm. For color images the threshold α is applied to the sum of the red, green, and blue values for each pixels. Next in step 126 the centroid of the all pixels above the threshold α is calculated. The x-y coordinates of the centroid are given by:

$$\begin{matrix}{X}_{c} = {\sum }_{x = 0}^{W - 1} {\sum }_{y = 0}^{H - 1} x \cdot {I}_{t} ( x , y ) & ( 3 ) \\ {Y}_{c} = {\sum }_{x = 0}^{W - 1} {\sum }_{y = 0}^{H - 1} y \cdot {I}_{t} ( x , y ) & ( 4 )\end{matrix}$$

Next, in step 128, the motion vector on image plane is computed by the displacement from the center of the image to the centroid as follows:
\overline{CD}=(X_{c},Y_{c})−(W/2,H/2) (5)

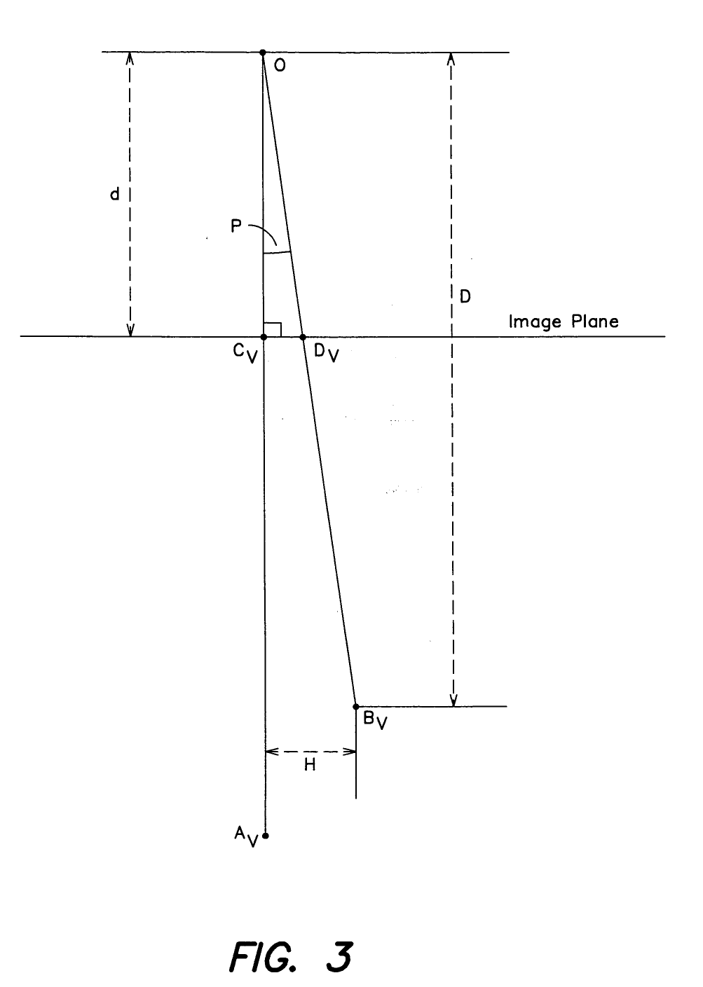

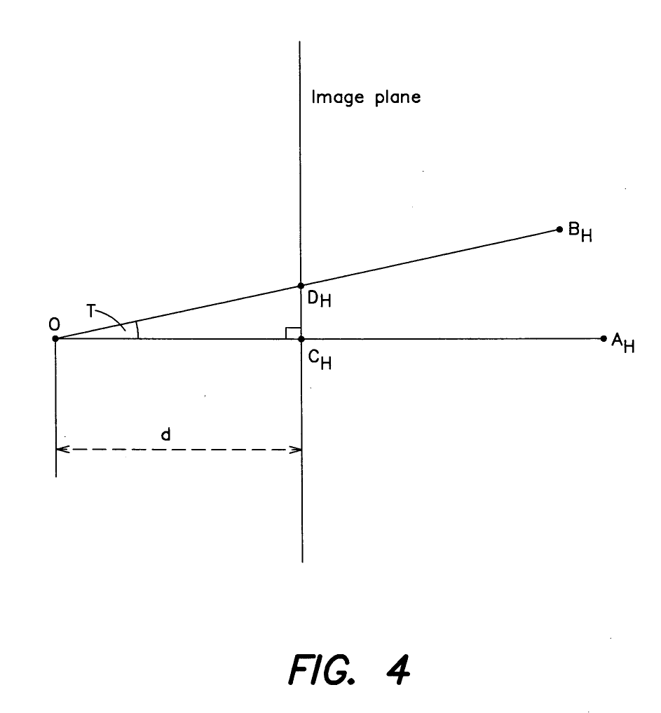

Step 130 determines the pan-tilt vector from the motion vector. A perspective model for the camera and its relationship with the camera mount, such as a pinhole model to approximate is used to approximate the camera. The model includes an image plane and point O, the focus of projection. Point O is on the Z-axis that is orthogonal to the Z-axis. Depicted in FIG. 3 and FIG. 4 are the vertical projection and horizontal projection of the pinhole model, respectively.

Referring to FIGS. 3 and 4, assume that at the time of the first image frame, A is the position of a point on the moving object. At the time of the second frame, the position of the same point on the moving object changes to B. In the images the pixel positions for A and B are, respectively, C and D. The vertical projections of these four points onto the X-Z plane are A_{V}, B_{V}, C_{V} and D_{V}. The horizontal projections of these four points onto the Y-Z plane are A_{H}, B_{H}, C_{H} and D_{H}.

The camera mount is automatically adjusted to keep the moving object at the center of the field of view of the camera. During the tracking process the object should be near the center of the field of view at the time of the first frame. Therefore, it is reasonable to assume that the segment OA is perpendicular to the image plane.

In order to track the moving object, the camera mount pans and tilts to a new direction so the object remains at the center of the field of vision of the camera. As shown in FIG. 3 and FIG. 4, the camera mount pans over an angle of P and tilts over an angle of T to ensure the new position, point B, at the center of the field of vision. The pan-tilt vector (in radians) is given by:
\overline{OO}′=(P,T) (6)

The motion vector \overline{CD} has the vertical and horizontal components on image plane:
\overline{CD}=\overline{C_{V}D_{V}}+\overline{C_{H}D_{H}} (7)

These components are computed as follows:
\overline{C_{V}D_{V}}=(X_{c}−W/2,0) (8)
\overline{C_{H}D_{H}}=(0,Y_{c}−H/2) (9)

The pan-tilt vector is determined as follows:

$$\begin{matrix}P \approx \frac{{C}_{v} {D}_{v}}{d} = \frac{{X}_{c} - W / 2}{d} & ( 10 ) \\ T \approx \frac{{C}_{H} {D}_{H}}{d} = \frac{{Y}_{c} - H / 2}{d} & ( 11 )\end{matrix}$$

where d is the distance between the focus point O and image plane.

### EXAMPLE

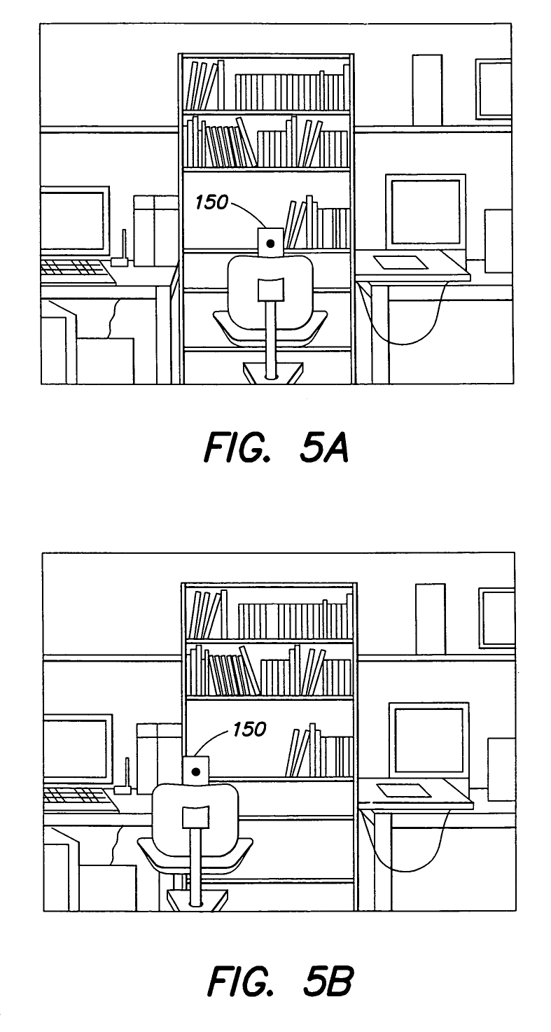

An experiment was designed to determine how the distance value d of Equations 10 and 11 should be set. As shown in FIG. 5A, a white card 150 with a black dot at the center of the card was the object. The card 150 was placed in front of the camera so that the black dot appeared at the center of the captured image. As shown in FIG. 5B, after the image illustrated in 5A was taken, the card was moved slightly for the second image shown in FIG. 5B.

Referring to FIG. 3, the position of the black dot within the white card 150 (FIG. 5A) was A_{V} when the first image was recorded. The corresponding location on image plane was C_{V}. And when the second image (FIG. 5B) was recorded, the position of the black dot was B_{V} and the corresponding location on the image plane was Dᵥ. The parameters H, D, and C_{V}D_{V} were measured by use of image analysis software. The angle P can be expressed as:

$$P \approx \frac{H}{D} \qquad ( 12 )$$

From Equation (10) and (12), the distance d can be computed as:

$$d = \frac{{C}_{v} {D}_{v}}{H} D \qquad ( 13 )$$

If the black dot on the white card 150 (FIGS. 5A and 5B) moves in a plane parallel to the image plane, the value of C_{V}D_{V}/H is a constant. This plane, which is parallel to the image plane, is referred to as the object plane. The distance between O and object plane is D. If the location of the black dot on the white card 150 on the image plane is plotted according to the position of the black dot in the object plane, a straight line results. The slope of the straight line is the constant C_{V}D_{V}/H. By repeating this experiment in object planes with different D a set of straight lines is obtained. For different straight lines, assume the slope is Kᵢ, the distance between O and object plane is Dᵢ.
d=Kᵢ·Dᵢ (14)

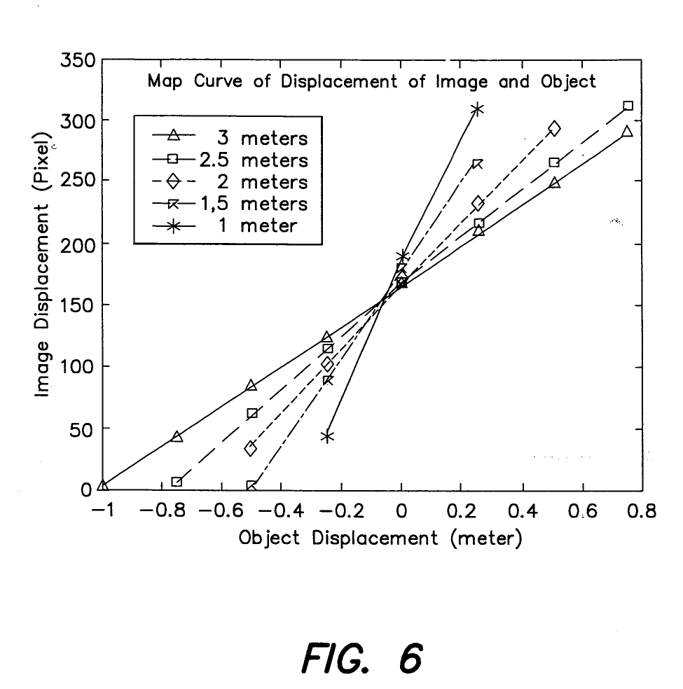

From Equation (14) and the data in FIG. 6, the distance d is computed. In this case, the result is d=0.25 (Pixel/radian). As d is known, the routine disclosed above is used to control the camera mount and track a moving object with the camera in real-time. That is, solutions for Equations 10 and 11 can be computed to determine the pan and tilt vectors, respectively.

The foregoing description has been limited to a specific embodiment of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

1. A method for tracking the motion of an object with an image recording device that comprises:
recording a first image of an object to be tracked;
recording a second image of said object to be tracked;
analyzing data from said first and second images to provide a difference image of said object, said difference image comprised of pixels;
thresholding said difference image to provide a threshold;
calculating the centroid of said pixels above the threshold;
determining the center of said difference image;
determining a motion vector from the displacement from said center to said centroid;
determining a pan tilt vector based on said motion vector; and
moving the image receiving device based on said pan tilt vector to track the object.

2. The method of claim 1 wherein said recording a first image, said recording a second image, said analyzing, said thresholding, said calculating, said determining the center, said determining a motion vector and said determining a pan tilt vector are performed in a closed loop.

3. A system for tracking the motion of an object in real-time which comprises:
a camera that captures a first image of an object to be tracked and a second image of said object to be tracked;
means for analyzing said first and second images to provide a difference image, said difference image comprised of pixels;
means for thresholding said difference image to provide a threshold;
means for calculating the centroid of said pixels;
means for determining a motion vector defined by the displacement from the center of said difference image to said centroid;
means for determining a pan tilt vector based on said motion vector; and
means for moving said camera based on said pan tilt vector to track the object.
